(19) United States
(12) Patent Application Publication
(10) Pub. No.: US 2022/0281504 A1
(43) Pub. Date: Sep. 8, 2022

(54) HYGIENIC PEEL-OFF PAPER ROLL FOR CART HANDLE

(71) Applicant: Mitchell Van Heyningen, Valley Stream, NY (US)

(72) Inventor: Mitchell Van Heyningen, Valley Stream, NY (US)

(21) Appl. No.: 17/493,961

(22) Filed: Oct. 5, 2021

Related U.S. Application Data
(60) Provisional application No. 63/135,127, filed on Mar. 2, 2021.
(60) Provisional application No. 63/159,144, filed on Mar. 10, 2021.

(51) Int. Cl. B62B 5/06; B32B 1/08; B32B 7/06; B32B 7/12; B32B 29/00

(52) U.S. Cl. CPC B62B 5/069; B32B 1/08; B32B 7/06; B32B 7/12; B32B 29/005; B32B 2250/05; B32B 2250/26; B32B 2307/7265; B32B 2307/7163; B32B 2260/028; B32B 2260/04; B32B 2571/00

(57) ABSTRACT

A hygienic peel-off paper roll for application to a cart handle comprises a paper roll formed of a semi-rigid tube and a plurality of sheets of paper wrapped around the tube, wherein the paper roll is sized to accommodate the diameter and length of the cart handle and provided with a slit therethrough along its length such that the paper roll may be applied to and cover the handle by forcing it onto the handle at the slit, to cause the paper roll to flex outwardly and over the handle and resiliently return to its original shape on the handle. The sheets are preferably adhered to the tube at the opposite ends of the tube, and a top one of the sheets of paper may be removed from the paper roll to thereby expose a sheet underneath the top one of the sheets.

### CROSS-REFERENCE TO RELATED APPLICATION

This application claims the benefit of U.S. Provisional Applications Ser. Nos. 63/135,127, filed Mar. 2, 2021, and 63/159,144, filed Mar. 10, 2021, the entire disclosures of which are hereby incorporated by reference.

### BACKGROUND OF THE INVENTION

The present invention relates to hygiene protection for handles, and in particular for handles of shopping carts, luggage carts, and the like.

It is well-known that viral and bacterial pathogens can be present on people's hands, whether or not they are infected with a particular pathogen. It is also well-known that such pathogens can survive on surfaces for several hours or more on surfaces. If a “recipient” person comes in contact with such surfaces, any pathogens on the surfaces may potentially infect the recipient if they touch their eyes, noses or mouth after contact with such surfaces. Of particular concern are surfaces that are routinely touched by many people over a short timeframe, as is the case with cart handles. The problem is made worse in the context of shopping carts insofar as pathogens can be physically transmitted from an affected cart handle, to food and/or household products, and then to others who may handle such objects at a later time.

The foregoing, of course, is of particular concern during a pandemic, such as that experienced with Covid-19.

Thus, there is a particular need to eliminate or at least dramatically reduce transmission of pathogens by physical contact with frequently touched surfaces, and in particular, cart handles such as those on shopping or luggage carts.

### SUMMARY OF THE INVENTION

The present invention is directed to apparatus for application to a cart handle, comprising a paper roll formed of a semi-rigid tube and a plurality of sheets of paper wrapped around the tube, wherein the paper roll is sized to accommodate the diameter and length of the cart handle and provided with a slit therethrough along its length such that the paper roll may be applied to and cover the handle by forcing it onto the handle at the slit, to cause the paper roll to flex outwardly and over the handle and resiliently return to its original shape on the handle. The sheets are preferably adhered to the tube at the opposite ends of the tube, and a top one of the sheets of paper may be removed from the paper roll to thereby expose a sheet underneath the top one of the sheets.

The sheets are preferably provided with a tab and perforations near the opposite ends of the tube to facilitate the removal of the top one of the sheets. The sheets are preferably comprised of waxed, water-resistant, biodegradable paper, are approximately 0.004″ thick, and the paper roll preferably includes from approximately 63 to approximately 125 sheets. The tube may be comprised of cardboard.

The apparatus may further include a pair of annular clamps adapted to secure opposite ends of the paper roll to the handle. Each of the annular clamps preferably includes a hinge, which when opened, allows it to be applied to or removed from the paper roll and the handle.

### BRIEF DESCRIPTION OF THE DRAWINGS

These and other aspects, details and objects of the invention will be described with reference to the following drawing figures of which:

FIG. 1 is a perspective view of the hygienic cart handle with peel-off paper in accordance with an exemplary embodiment of the present invention;

FIG. 2 is a cross-section of sheets of peel-off paper wrapped around a cardboard tube in accordance with an exemplary embodiment of the present invention;

FIGS. 3A-3C illustrate an example of the way the peel-off paper and cardboard tube can be applied to a cart handle;

FIGS. 4A and 4B are perspective views of examples of the inner and outer portions of the end clamp used in the example of FIG. 1; and

FIG. 5 is a detail view of the end clamp securing one end of peel-off paper and cardboard tube to the cart handle.

### DETAILED DESCRIPTION OF THE INVENTION

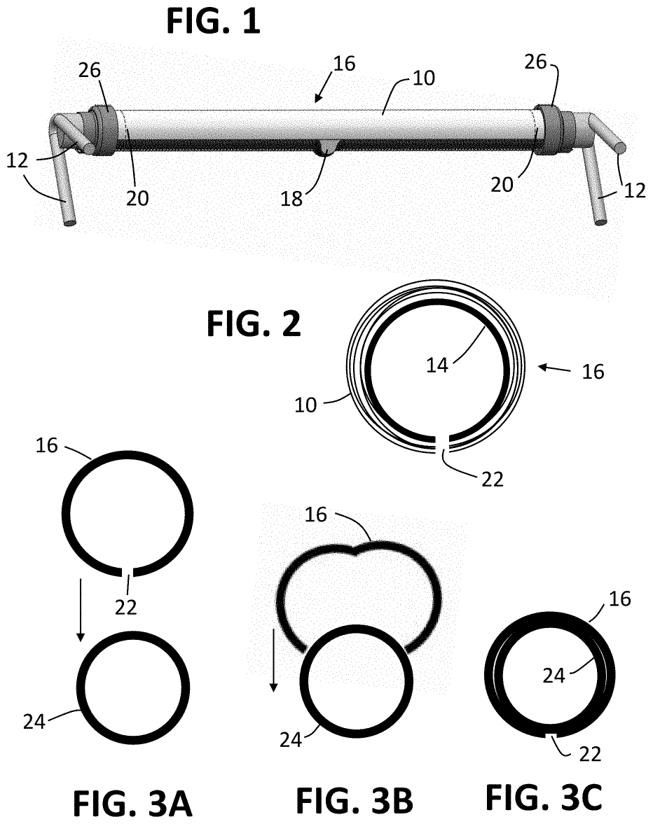

A hygienic cart handle having peel-off paper 10 in accordance with an example of the present invention is shown in FIG. 1. The cart handle is attached to the cart by brackets 12. The peel-off paper 10 is preferably formed from sheets of waxed, water-resistant, biodegradable paper wrapped around a semi-rigid tube 14, FIG. 2, preferably made of cardboard, to create a peel-off paper roll 16 which is applied to an unprotected cart handle as will be described below. The paper roll is preferably sized to accommodate the diameter and length of said cart handle. In accordance with a preferred embodiment, each sheet may be approximately 0.004″ thick, and approximately 63-125 sheets may be used for each paper roll 16, although other sheet thicknesses and sheet counts can be selected as desired. To maintain the structural integrity of the paper roll 16, the sheets 10 may be adhered to each other and to the tube 14, at the ends of the tube, in a manner similar to a book binding. Each paper sheet is provided with a tab 18 that the user may grab to initiate the removal of the top sheet, and circumferential perforations 20 may be provided at the ends of the paper roll to facilitate the removal of the top sheet therefrom.

In use, before any other portion of the cart is touched, the user will grip the tab 18 of the top sheet and pull the sheet away from the paper roll to thereby separate the top sheet from the handle at the perforations 20. The top sheet may then be discarded. The user then may grip the newly exposed sheet on the paper roll 16, which sheet has neither been touched by any other person, nor exposed to the atmosphere, thus eliminating, or at least dramatically reducing, the chance of contacting a pathogen on the cart handle.

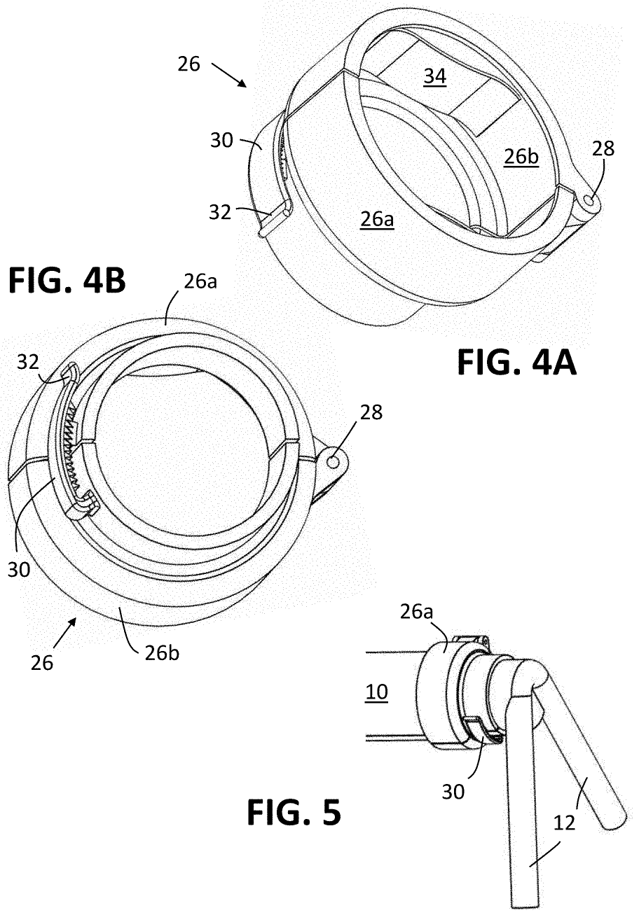

With reference to FIGS. 2 and 3A-3C, the paper roll 16 is provided with a lengthwise slit 22. To install the paper roll 16 on an unprotected cart handle 24, the paper roll 16, at the slit 22, is forced down upon the handle 24. As shown in FIG. 3B, the paper roll will flex outwardly to accommodate the handle 24, and will resiliently return to its original shape, surrounding the handle 24, as shown in FIG. 3C. The process is simply reversed to remove a spent paper roll from the handle.

The paper roll 16 may optionally be secured to the handle 24 by annular clamps 26, which can be identical, as shown in FIG. 1. Details of exemplary clamps are shown in FIGS. 4A and 4B. FIG. 4A best illustrates the interior of the clamp, i.e., that portion of the clamp into which an end of the paper roll is inserted, and FIG. 4B illustrates the exterior portion of the clamp which is positioned adjacent the cart brackets 12. Each clamp is formed of two halves 26a and 26b, connected by a hinge 28. The halves are provided with a mating ratchet-type closure 30, including a release tab 32, which allows the clamps to be opened, by lifting the tab 32. The clamps can be securely closed through the ratchet action of the closure 30. Finally, the clamp 26 is provided with a leaf spring 34 which bears upon the ends of the paper roll to secure the roll 16 to the handle 24. To replace a used paper roll, and to insert a new paper roll, the clamps 26 on both ends of the paper roll are removed from the handle, the spent paper roll is removed, a new paper roll is pressed onto the handle as shown in FIGS. 3A-3B, and the clamps 26 are applied to the ends of the paper roll to secure it to the handle.

Thus, the present invention provides a hygienic, pathogen free cart handle for users to grip, thereby reducing the likelihood of transmission of pathogens from the handle to the user.

While the foregoing is directed to preferred embodiments of the present invention, further changes, objects, aspects and embodiments of the present invention will be appreciated by those in the art, without departing from the scope of the invention, which will be defined by the following claims.

What I claim is:

1. Apparatus for application to a cart handle, comprising:
a paper roll formed of a semi-rigid tube and a plurality of sheets of paper wrapped around said tube;
wherein said paper roll is sized to accommodate the diameter and length of said cart handle and provided with a slit therethrough along its length such that said paper roll may be applied to and cover said handle by forcing it onto said handle at said slit, to cause said paper roll to flex outwardly and over said handle and resiliently return to its original shape on said handle.

2. The apparatus of claim 1 wherein said sheets are adhered to said tube at the opposite ends of said tube, and a top one of said sheets of paper may be removed from said paper roll to thereby expose a sheet underneath said top one of said sheets.

3. The apparatus of claim 2 wherein said sheets are provided with a tab and perforations near said opposite ends of said tube to facilitate the removal of said top one of said sheets.

4. The apparatus of claim 3 wherein said sheets are comprised of waxed, water-resistant, biodegradable paper.

5. The apparatus of claim 4 wherein said sheets are approximately 0.004″ thick, and said paper roll includes from approximately 63 to approximately 125 sheets.

6. The apparatus of claim 5 wherein said tube is comprised of cardboard.

7. The apparatus of claim 1 further comprising a pair of annular clamps adapted to secure opposite ends of said paper roll to said handle.

8. The apparatus of claim 7 wherein each of said annular clamps includes a hinge, which when opened, allows it to be applied to or removed from said paper roll and said handle.
